(19) United States
(12) Patent Application Publication
(10) Pub. No.: US 2026/0203493 A1
(43) Pub. Date: Jul. 16, 2026

(54) Enhanced Interactive Writing Tool that Allows Writers to Draft and Revise a Text Authentically and Efficiently Using a Large Language Model While Reducing Academic Misconduct

(71) Applicant: Carnegie Mellon University, Pittsburgh, PA (US)

(72) Inventors: Suguru ISHIZAKI, Pittsburgh, PA (US); David KAUFER, Pittsburgh, PA (US)

(73) Assignee: Carnegie Mellon University, Pittsburgh, PA (US)

(21) Appl. No.: 19/522,826

(22) PCT Filed: Sep. 30, 2024
(86) PCT No.: PCT/US2024/049216

§ 371 Date: Mar. 25, 2026

Related U.S. Application Data
(60) Provisional application No. 63/541,399, filed on Sep. 29, 2023.

(51) Int. Cl. G06F 40/166; G06F 3/04842

(52) U.S. Cl. CPC G06F 40/166; G06F 3/04842

(57) ABSTRACT

The present invention relates to a method and system for generating coherent Al generated text from text segments using an interactive generative artificial intelligence software whereby text segments are concatenated to predefined natural language sentences to generate coherent Al generated text from the selected text without adding new ideas. The Al generated text can be traced back to the original text segment and the quality of the Al generated text can be rated.

### CROSS-REFERENCE TO RELATED APPLICATIONS

This application claims priority to U.S. Provisional Application Ser. No. 63/541,399, filed Sep. 29, 2023, which is incorporated by reference herein in its entirety.

### BACKGROUND OF THE INVENTION

### Field of the Invention

The present invention relates to an interactive writing tool designed to enhance the writing process by using generative artificial intelligence (“AI”) technology.

### Description of Related Art

Generative AI has been integrated across a wide array of writing environments, from email tools to word processors. While generative AI has functioned non-controversially for crafting highly structured content, such as birthday messages to acquaintances, and for composing brief responses to utilitarian emails, it presents a serious source of concern when applied to more substantial writing contexts, such as academic assignments, scientific articles, or legal documents. In such contexts, writers are challenged to sort out their claims of textual ownership over text that has been automatically generated. Generative AI has sparked widespread concerns among administrators and educators in higher education settings, primarily concerns about violating academic integrity. Some educators recognize the potential of generative AI but fear that it might overshadow students' creative efforts or even diminish their motivation to write authentically. To address these apprehensions, embodiments of the invention aim to provide valuable assistance to users, while preserving their agency and fostering independent learning and academic integrity. AI can be most helpful and least invasive when used to help writers turn their written notes into AI generated text, and when the AI generated text created by the AI adds no new ideas. Similarly, the U.S. Copyright Office currently maintains that there is no copyright protection for works created by non-humans, such as an AI algorithm, and it is unclear how authors can claim ownership of a text generated with generative AI. This invention can provide an alternative approach that opens a path for writers to make ownership claims over original text generated in conjunction with text generated by AI.

While numerous writing tools leverage generative AI technology, various embodiments of the present invention are distinctive from and provide an improvement over such existing tools by generating text from the author's (or “user” interchangeably herein) notes without introducing novel ideas or concepts. Additionally, the present invention facilitates iterative review and revision of drafts by visualizing the key features of composition, including content expectations, paragraph coherence, sentence coherence within paragraphs, and sentence density. The iterative review of drafts can be supported by multiple tools within embodiments of the present invention, one of which focuses on the novel feature and function of “content expectations.” Other known tools and methods can be incorporated into various embodiments of the systems and methods of the present invention. Finally, embodiments of the present invention offer users a means to establish the copyrightable authenticity of their notes and content in relation to the machine-generated content.

### BRIEF SUMMARY OF THE INVENTION

While multiple embodiments are disclosed, still other embodiments of the present invention will become apparent to those skilled in the art from the following Detailed Description and figures, which show and describe illustrative embodiments of the invention. As will be realized, the invention is capable of modifications in various aspects, all without departing from the scope of the present invention. Accordingly, the figures and Detailed Description are to be regarded as illustrative in nature and not restrictive.

One embodiment of the present invention is a computer-implemented method for transforming notes into machine generated text using an electronic device having one or more processors and a display with a user interface and a text editor. The method of this embodiment comprises the following steps: selecting a text segment in the text editor; selecting, through a user interface, generating text from the text segment via the large language model algorithm; displaying the generated text in a separate text field in the user interface; and inserting the generated text into the text editor. For this embodiment, the generation of text from the text segment comprises the following steps: concatenating the selected text segment to a predefined natural language text template to produce a text string; submitting the text string to a large language model algorithm via a network connection to a remote server; and generating text from the text segment via the large language model algorithm.

Another embodiment of the present invention is an electronic device having a display, a memory, one or more processors, and one or more programs. For this embodiment, the one or more programs are stored in the memory and configured to be executed by the one or more processors. Additionally, the one or more programs include instructions for: selecting a text segment in the text editor; selecting, through a user interface, generating text from the text segment via the large language model algorithm; displaying the generated text in a separate text field in the user interface; and inserting the generated text into the text editor. For this embodiment, the generation of text from the text segment comprises the following steps: concatenating the selected text segment to a predefined natural language text template to produce a text string; submitting the text string to a large language model algorithm via a network connection to a remote server; and generating text from the text segment via the large language model algorithm.

A third embodiment of the present invention is a system for transforming notes into machine generated text using an electronic device having one or more processors and a display with a user interface and a text editor. The system of this embodiment comprises a user interface accessible via the display that comprises the following: a notes/machine generated text panel, a text editor, and an assessment panel. For this embodiment, the user interface is in two-way communication with a machine generated text generator and an expectations analyzer, which communicate with each other. Prompt templates interface with the machine generated text generator and the expectation analyzer. A genre specific expectations sets provides information to the expectations analyzer. A large language model algorithm receives prompts from the machine generated text generator and the expectation analyzer and sends responses to the machine generated text generator and the expectation analyzer.

### BRIEF DESCRIPTION OF THE SEVERAL VIEWS OF THE DRAWINGS

For the purpose of facilitating understanding of the invention, the accompanying figures and description illustrate preferred embodiments thereof, from which the invention, various embodiments of its structures, construction, method of operation, and many advantages, may be understood and appreciated. The accompanying drawings/figures are hereby incorporated by reference.

FIG. 1 is a flowchart that shows one embodiment of a method for transforming notes to AI generated text while recording revision activities according to the present invention;

FIG. 2 is a screen shot showing a maintained log of a user's original notes and the AI generated texts from the notes according to one embodiment of the present invention;

FIG. 3 is a screen shot showing AI generated text traced back to the user's original notes according to one embodiment of the present invention;

FIG. 4 is a flowchart that shows one embodiment of a method for identifying sentences that meet an information expectation of a specific genre or an assignment;

FIG. 5 is a flowchart that illustrates one method for a user to highlight the sentences that meet the expectations of a specific genre or an assignment according to one embodiment of the present invention;

FIG. 6 illustrates one embodiment of a user-interface with an expectation panel displaying a suggested outline for a writing assignment with a set of content expectations;

FIG. 7 illustrates one embodiment of how the outline and expectations of FIG. 6 are copied from the user-interface and pasted into a text editor;

FIG. 8 illustrates one embodiment of how, when a user selects an expectation, a user-interface displays a detailed description of the selected expectation;

FIG. 9 illustrates one embodiment of a user writing notes for an expectation in a text editor;

FIG. 10 illustrates one embodiment of a user selecting notes in a text editor to be converted into AI generated text;

FIG. 11 illustrates one embodiment of a paragraph generated from text notes and how a user can replace the selected notes with the newly generated paragraph;

FIG. 12 illustrates one embodiment of how a generated paragraph can replace the user-generated notes;

FIG. 13 illustrates one embodiment of how a user completes the drafting process and an expectation panel indicates if the expectations are met;

FIG. 14 illustrates one embodiment of how a system of the present invention allows a user to assess if and how each expectation is met;

FIG. 15 illustrates one embodiment of topical organization of a user's draft;

FIG. 16 illustrates one embodiment of topical organization of a paragraph;

FIG. 17 illustrates one embodiment of how a user can revise notes and generate a new paragraph;

FIG. 18 illustrates one embodiment of a flowchart illustrating a process for generating a prompt for generating AI generated text from notes;

FIG. 19 illustrates one embodiment of a sample template for generating AI generated text from notes;

FIG. 20 illustrates one embodiment of a flowchart that shows a process for generating a prompt for identifying paragraphs that meet a specific expectation;

FIG. 21 illustrates a sample template for identifying sentences that meet a specific expectation;

FIG. 22 illustrates one embodiment of a flowchart that shows a schematic overview of a typical implementation of one embodiment of the present invention method embedded with a text editor; and

FIG. 23 illustrates one embodiment of a system according to the present invention.

### DETAILED DESCRIPTION OF THE INVENTION

The following describes example embodiments in which the present invention may be practiced. This invention, however, may be embodied in many different ways, and the descriptions provided herein should not be construed as limiting in any way. Among other things, the following invention may be embodied as methods, systems, or devices. The following detailed descriptions should not be taken in a limiting sense. The accompanying drawings/figures are hereby incorporated by reference.

The phrases “in some embodiments”, “in one embodiment”, “in various embodiments”, “according to various embodiments”, “in the embodiments shown”, “in other embodiments”, and the like generally mean the particular feature, structure, or characteristic following the phrase is included in at least one embodiment of the present invention and may be included in more than one embodiment of the present invention. In addition, such phrases do not necessarily refer to the same embodiments or to different embodiments.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The methods, systems, applications, and processes described herein can be implemented as a series of computer-readable instructions, embodied or encoded on or within a tangible data storage medium or in a cloud-based storage system, that when executed are operable to cause one or more processors to implement the operations described above. While the foregoing processes and mechanisms can be implemented by a wide variety of physical systems and in a wide variety of network and computing environments or on an individual computer, the computing systems described below provide example computing system architectures and are for didactic, rather than limiting, purposes.

Various embodiments of the present invention provide for a computer-implemented method for converting notes to AI generated text using AI. In accordance with some embodiments, a user interface screen can be displayed on a terminal or display (e.g., computer, mobile device, etc.)

Embodiments of the present invention also include computer-readable storage media containing sets of instructions to cause one or more processors to perform the methods, variations of the methods, and other operations described herein.

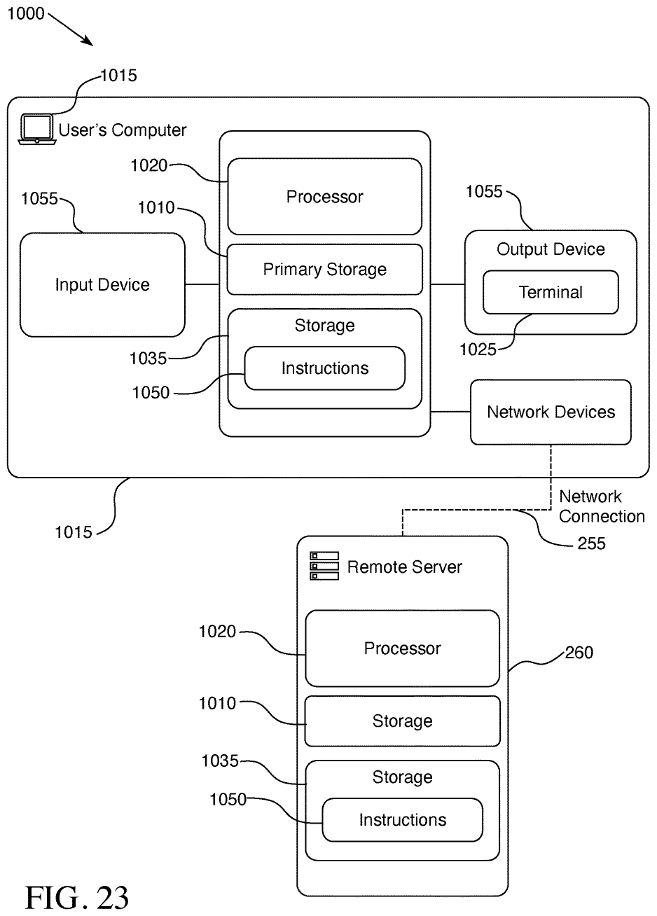

Various embodiments of the present invention include a system 1000 or electronic device 1015 comprising one or more of the following: a display device 1025, non-transitory computer-readable storage medium (memory) 1010, 1035, an input/output device 1055, a user-interface 10330, an LLM 250, a network connection 255, a remote server 260, a text editor program 1040, and a processor 1020. All these components are combined as is generally known in the art and one embodiment of their arrangement is illustrated in FIG. 23. The processor 1020 can be in communication with the display 1025, input/output device 1055, and operable to execute instructions 1050 stored in memory 1010, 1035 (see FIG. 23). The display 1025 provides to the user 1 access to the user interface 1030 (“UI”). In some embodiments, the processor-executable instructions 1050 can cause the processor 1020 to communicate display data to the display input/output device 1025 to cause a user interface 1030 to be displayed on the display device 1025. The user interface 1030 may include an interactive text editor 1040 (or writing software) through which a set of customized rules and responses can be entered by a user 1. The interactive text editor 1040 can be used to visually indicate the relationship between the set of customized rules.

While the disclosure has been described in detail and referring to specific embodiments thereof, it will be apparent to one skilled in the art that various changes and modifications can be made without departing from the spirit and scope of the embodiments. Thus, it is intended that the present disclosure covers the modifications and variations of this disclosure provided they come within the scope of the appended claims and their equivalents.

It is to be understood that the invention may assume alternative variations and step sequences, unless specified to the contrary. It also is to be understood that the specific devices and processes illustrated in the attached drawings and described in this specification are simply exemplary embodiments of the invention. Hence, specific dimensions and other physical characteristics related to the embodiments disclosed are not to be limiting.

Various embodiments of the invention include methods 100 and systems 1000 to automatically transform user-generated text segments 200 into cohesive AI generated text 205 and maintain fidelity to the original content without introducing new ideas. Embodiments of the invention maintain a detailed record (or log 114 and 116) of the writing process and enable the generated text (AI generated text 205) to be traced back to the author's original notes 200 or external sources. Additionally, the invention facilitates iterative review and revision of drafts by visualizing the key features of composition, including content expectations 210, paragraph coherence 225, and sentence coherence 235 within paragraphs 220. As used herein, “text segment 200” comprises any written content that is selected by the user 1 for input into the systems 1000 and methods 100 of the present invention. “Text segments 200” can be user generated (original content), AI generated, or user selected (such as identifying and copying from a third-party source). As nonlimiting examples, “text segments 200” include any user generated content (whether original material or from a third-party source) including but not limited to notes, bulleted lists, user-authored writing, user-selected writing, spatial notes (such as diagrams, mind-maps, etc.) and/or AI generated content of all the previously-identified types and formats, which is selected by the user 1 as input to the systems 1000 or methods 100 of the present invention. In some embodiments, “text segments 200” can include prompts 245 and AI generated text 205, where the prompt 245 or AI generated text 205 are selected by the user (or an AI system) to be used as input into a system 1000 or method 100 of the present invention. It will be obvious to one skilled in the art that there are numerous ways to input text segments 200 into the systems 1000 and methods 100 of the present invention including by not limited to typing the text segment 200 directly into a text editor program 1040; using dictation or transcription technologies; generating text segments 200 directly from brain scanning technology; using a mouse, pointer, or other selection technology; and using copy or cut and paste technologies. Within this document, “text segment 200” and “notes 200” are used interchangeably.

As used herein, “prose 205”, “text 205”, “machine generated text 205”, “generated text 205”, and “AI generated text 205” are used interchangeably to include any text that is generated by the methods 100 and systems 1000 of the present invention (in other words, the output of the present invention). Nonlimiting examples of AI generated text 205 include those previously mentioned and AI generated text, AI generated paragraphs, AI generated sentences, and AI generated bulleted lists.

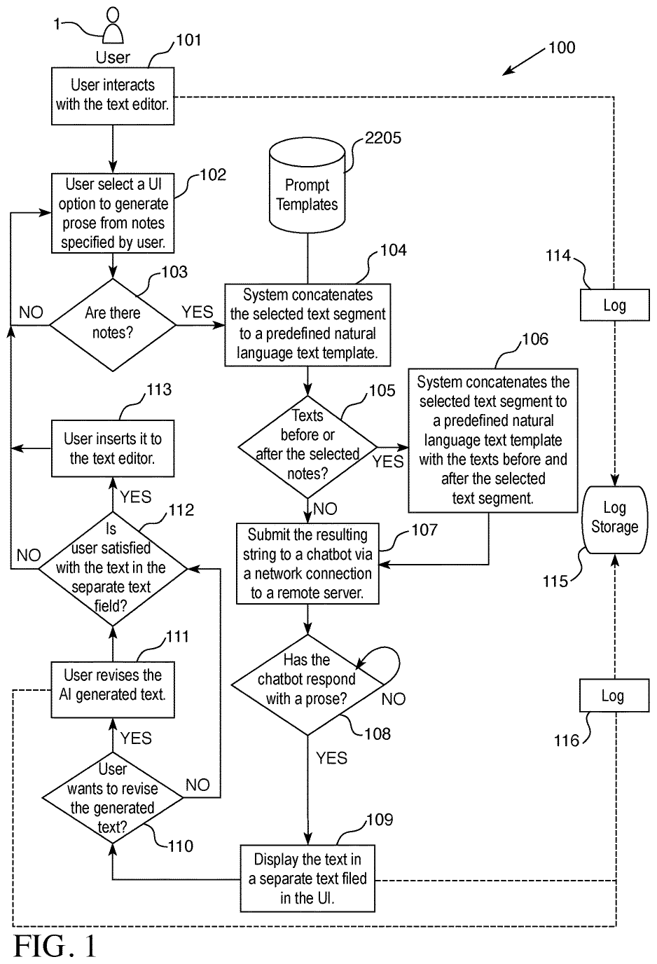

The present invention, in one embodiment illustrated in FIG. 1, is a computer-implemented method 100 for transforming notes 200 into AI generated text 205 using an interactive writing software 1005, comprising executing on a processor 1020 the steps of: (1) selecting a user-generated text segment 200 (i.e., notes 200) in a text editor 1040, the text editor 1040 having or being incorporated into a user-interface 1030 (see FIG. 1 at 101, 102); (2) interacting with the user-interface 1030 to generate AI generated text 205 from the text segment 200 (see FIG. 1 at 102 to 109 and 114 to 116); (3) concatenating a selected text segment 200 to a predefined natural language text template 240 to produce a text string 245 (interchangeably herein known as “prompt 245”) (see FIG. 1 at 104 to 106); (4) submitting the text string 245 to an LLM 250 via a network connection 255 to a remote server 260 (see FIG. 1 at 107 and 108)(this step also can be configured to run locally on a computer(s) or electronic device); (5) the LLM 250 generates AI generated text 205 from the notes 200 (see FIG. 1 at 107 and 108); (6) displaying the text string 245 returned from the LLM 250 in a separate text field 265; and (7) inserting the text string 245 into the text editor 1040. In this context, the text editor 1040 is typically a conventional text editor 1040, such as Microsoft® Word or Google® Docs. The text string 245 returned from the LLM 250 is typically AI generated text 205 (i.e., a paragraph 220), but it may also be a list of sentences 230 or phrases when appropriate.

As used herein, “LLM 250” is short for “large language model” or “large language model algorithm”, which are generally known to one skilled in the art. The present invention utilizes LLM technology to serve the purposes explained herein including but not limited to recognizing how words are used, to generate AI generated text 205 from notes 200, or to assess how a text segment 200 meets the expectation 210 of its intended readers. Chatbots are one non-limiting example of an application that interfaces with LLMs. Various embodiments of the present invention's systems 1000 and methods 100 can be configured to incorporate interfaces (such as chatbots) or to function without such interfaces.

Embodiments of the present invention distinctively generate grammatically correct text 205 from a user's notes 200 without introducing novel ideas or concepts. Notes 200, as mentioned previously, may take a wide range of forms, and may not always follow standard rules of grammar. Embodiments of the invention confine text 205 generation exclusively to ideas encapsulated within the user's original notes 200 allowing users 1 to concentrate on the high-level content creation process, while reducing the burden of lower-level writing tasks (e.g., sentence structuring, word choices, punctuation, grammar correction, sentence combining, etc.), which demands significant cognitive load and is known to draw the inexperienced writer's attention away from the higher-level planning and critical thinking necessary for original writing. Further, users 1 can quickly assess the presence of information anticipated by prospective readers within the text and have the ability to rate the quality of the information.

Additionally, various embodiments of the present invention provide for a computer-implemented method 100 and a related system 1000 configured to be accessed by a user interface 1030 displayed on a terminal 1025 (e.g., computer, mobile device, etc.). Embodiments of the present invention also include memory 1035 and/or computer-readable storage media 1010 containing sets of instructions 1050 to cause one or more processors 1020 to perform the methods 100, variations of the methods 100, and other operations described herein.

Various embodiments of the present invention include a system 1000 comprising a display device 1025, an input/output device 1055 (such as a mouse, keyboard, microphone), a memory 1010, and a processor 1020. One embodiment of a system 1000 of the present invention is illustrated in FIG. 23. The processor 1020 can be in communication with the display 1025 and input/output device(s) 1055 and operable to execute instructions 1050 stored in memory 1035, 1010. A common embodiment of a display 1025 is a visual one, but it may also include other types, such as auditory and tactile displays 1025. The various parts and elements of the invention can be configured to run on a single electronic device 1015 or multiple electronic devices 1015 in communication with one another.

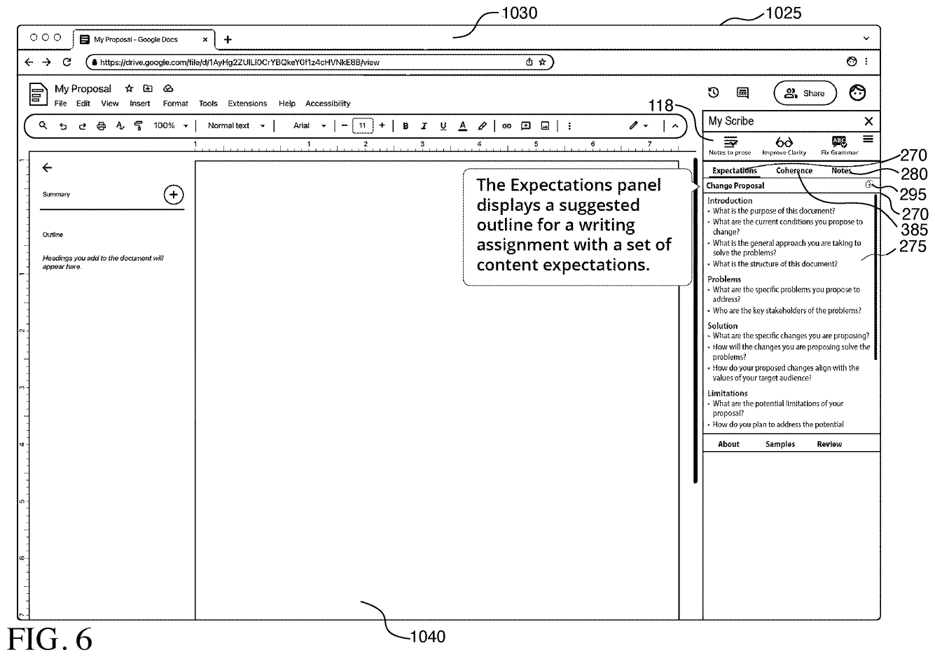

Two embodiments of the invention are a computer-implemented enhanced interactive writing system 1000 and a method 100, using a processor 1020 with memory 1010, that allows users 1 to draft and revise written content efficiently using a large language model 250 without losing the ownership of their authored content. The various embodiments of systems 1000 and methods 100 of the present invention can be configured as standalone writing applications or they can be incorporated as components of larger interactive writing tools that are designed to enhance the writing process by automatically transforming the initial notes 200 commonly found in the early stages of writing into cohesive AI generated text 205 without introducing new ideas. If there is written content, such as phrases, sentences 230, or paragraphs 220 before or after the notes 200 that are transformed into AI generated text 205, embodiments of the system 1000 and methods 100 can automatically include cohesive ties 207 between the new AI generated text 205 and existing phrases, sentences 230, or paragraphs 220 around it 205 (See FIGS. 6-17 and FIG. 22). Cohesive ties 207 are AI-generated text 205 that solidifies the fit or smooths the flow between the new AI generated text 205 and the phrases, sentences 230 or paragraphs 220 around it. Cohesive ties 207 can be as short as a single word or up to multiple, full sentences 230 configured to increase the cohesion between the AI-generated text 205 and the surrounding content.

FIG. 6 illustrates one portion of an embodiment of a method 100 or system 1000 showing a user-interface 1030 with an expectation panel 270 that displays a suggested outline 275 for a writing assignment with a set of content expectations 210. As illustrated in the embodiment shown in FIG. 6, the expectation panel 270 can be configured to appear next to the text editor 1040. The embodiment illustrated in FIG. 6 shows the novel ability of the present invention to provide a suggested outline 275 and content expectations 210 to the user 1 (carefully curated in some embodiments by writing and subject experts) to act as scaffolding for the user 1 when drafting.

The steps of one embodiment of a method 100 (which can be implemented by a system 1000) of the present invention are illustrated by the flowchart in FIG. 1. As shown, a user 1 interacts with a text editor 1040 (step 101). The user 1 selects a user interface (“UI”) 1030 option (step 102) to generate AI generated text 205 from text segment(s) 200 by identifying notes or text segments 200 (step 103). Once the notes 200 are identified, the method 100 (and implementing system 1000) concatenate the selected text segments 200 to a predefined natural language text template (step 104). If there is text before 2002 or after 2004 the selected text segment 200 (step 105), then the method 100 or system 1000 concatenates the selected text segment 200 to a predefined natural language text string 245 with the texts before 2002 and after 2004 the selected text segment 200 (step 106). The various methods 100 (for situations in which there is text before 2002 and after 2004 and no text before and after (step 105) then submit the resulting text string 245 (or prompt) to an LLM 250 (step 107) via a network connection 255 to a remote server 260. Once the LLM 250 responds with AI generated text 205 (step 108), then the method 100 illustrated in FIG. 1 generates and displays the text 205 or AI generated text 205 in a separate text field 265 in the UI 1030 (step 109). As shown in FIG. 1, the user 1 has the option of revising the generated text (step 110). If the user 1 is satisfied with the generated text 205 (shown in the separate field 265) (step 112) then the user 1 can insert the text 205 into the text editor 113. Otherwise, the user 1 can begin the method 100 again by selecting a text segment 200 as input (step 102). As shown in FIG. 1, the process is recorded and stored as log entries 114, 116 in a log storage device or system 115.

Various embodiments of the invention can be configured for use as an add-on application with a typical word processor program 1005, such as Microsoft® Word or Google® Docs; but it also can be more closely integrated with a standard or proprietary text editor 1040 (FIG. 6 showing a text editor program 1040 with the present invention illustrated as an expectations panel 270 on the side of the display 1025). As a non-limiting example, a proprietary text editor 1040 can include the following functional properties and/or tools: (1) the editor 1040 may visually differentiate (a) text segments 200 that are generated by an LLM 250 and (b) text segments 200 that are manually typed into the editor 1040 by the user 1; (2) a visual element (such as a small button) may be added near text that is generated by an LLM 250, and clicking it would open the notes 200 that were used to generate the text 205; and/or (3) the editor 1040 may differentiate text segments 200 that are copied and pasted from an external LLM 250.

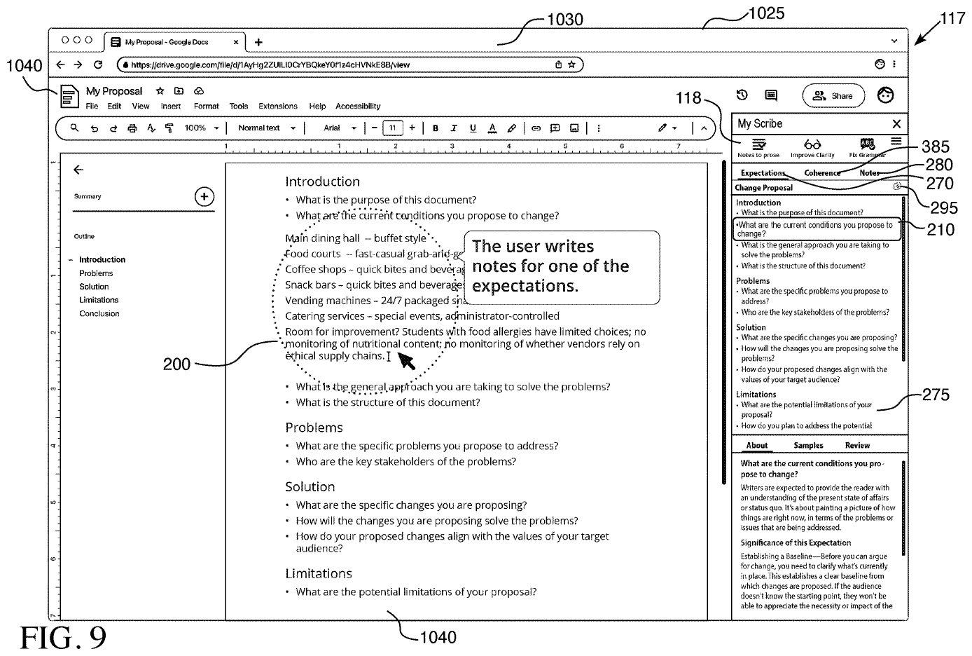

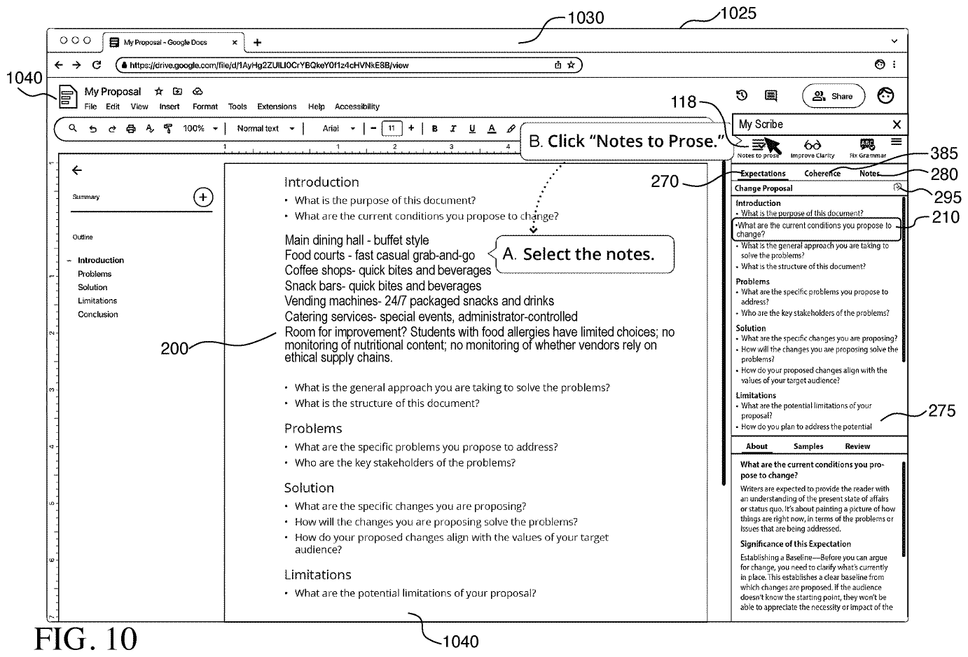

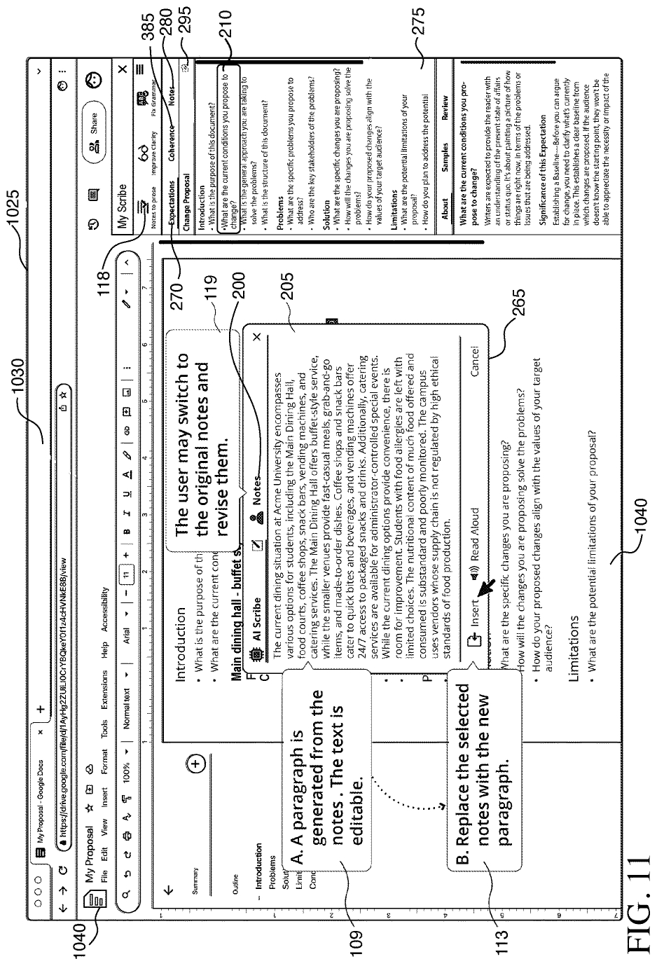

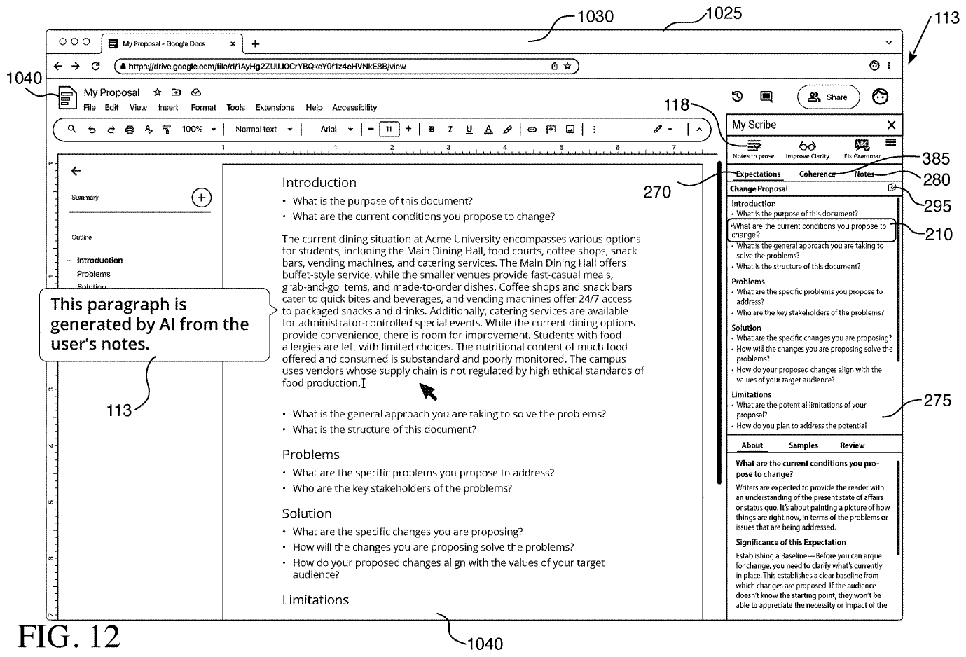

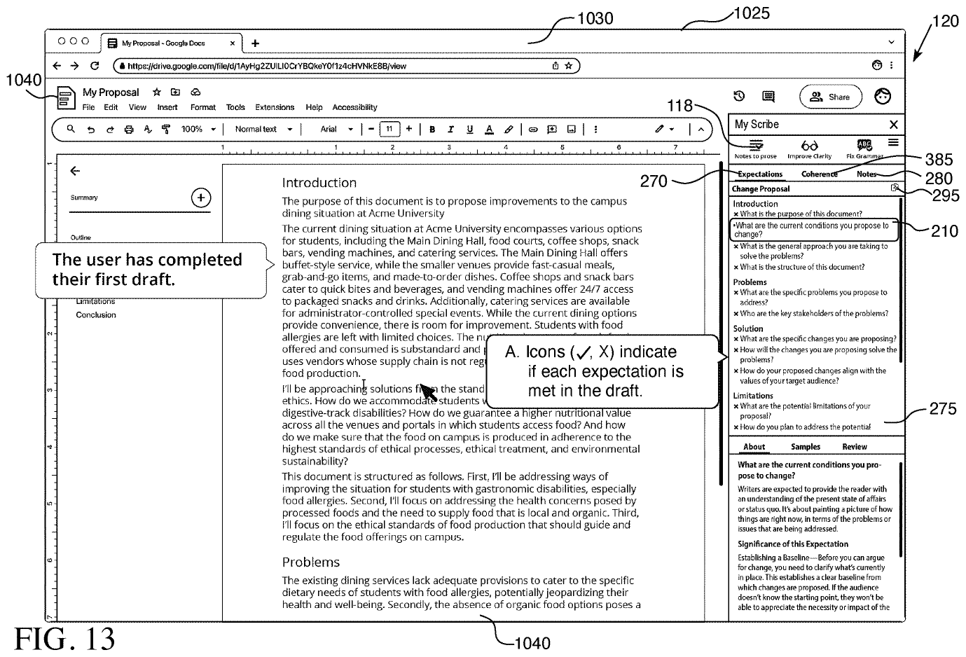

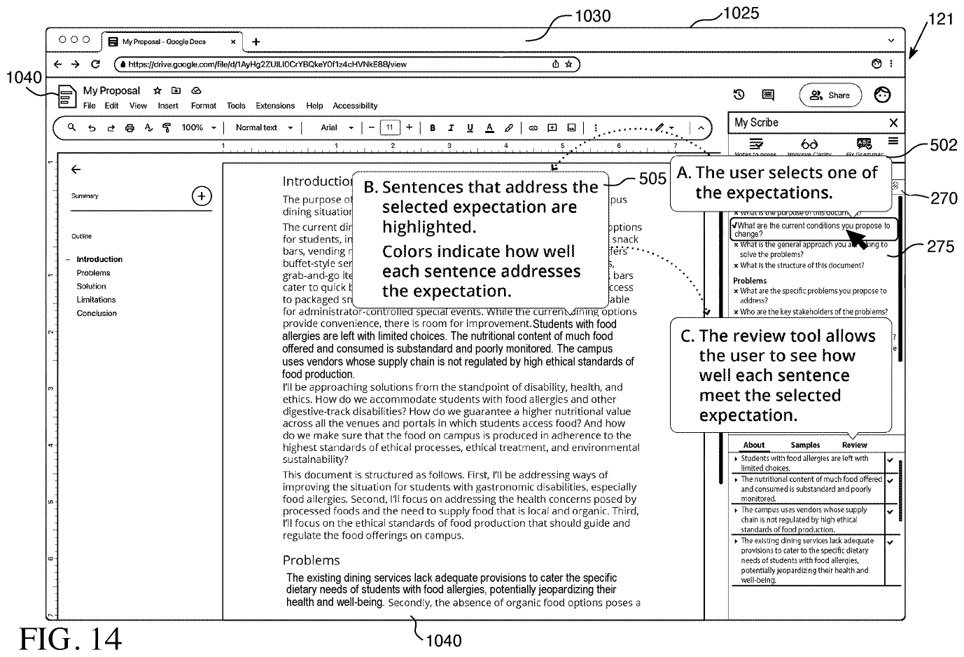

For some embodiments of the present invention, a short text 205 (such as a paragraph 220) is generated from user-provided input 200 (such as written notes 200 or a bulleted list of ideas 200). In these embodiments, there are two common ways to trigger this process depending on how the user interface 1030 is implemented (see FIGS. 9-12). As illustrated in FIG. 9, the user 1 drafts notes 200 for an expectation 210 in the text editor 1040 (FIG. 9 at 117). The user 1 then selects 102 the notes 200 in the text editor 1040 and indicates that the notes 200 are to be converted to AI generated text 205 (FIG. 10 at 118). FIG. 11 illustrates two possible options from which a user 1 can choose once AI generated text 205 has been generated 109. First, the user 1 can choose to replace the notes 200 with the AI generated text 205 (FIG. 11 at 113). Alternatively, the user 1 can revert back to the original notes 200 and revise them again (FIG. 11 at 119 and FIG. 1 at 102). A paragraph 220 of AI generated text 205 is generated from the text notes 200 and the user 1 can replace the selected notes 200 with the newly generated paragraph 205, 220 (FIG. 11). The present invention transforms the notes 200 into AI generated text 205 without adding any new concepts. The user 1 can choose to replace 113 the user-generated notes 200 with the system 1000 or method 100 AI generated text 205 (FIG. 12). In one embodiment, the user 1 can continue or complete the drafting process and the expectations panel 270 indicates if the expectations 210 are met (FIG. 13 at 120). This is illustrated in FIG. 13 where the system 1000 or method 100 can display an indicator 120A to show whether an expectation 210 is met 120. In other embodiments, the system 1000 or method 100 enables the user 1 to assess if and how each expectation 210 is met 121 (FIG. 14). One embodiment of this is illustrated in FIG. 14, wherein the user 1 selects one of the expectations 210 (shown at 121A in FIG. 14). The sentences 230 (or AI generated text 205) that address the selected expectation 210 are highlighted by the system 1000 or method 100 (for example by using a color scheme)(shown at 121B in FIG. 14). This embodiment enables the user 1 to see how well each sentence 230 of AI generated text 205 meets the selected expectation 210 (shown at 121C of FIG. 14). As explained with FIG. 1, then user 1 can restart or return to the initial step of identifying text segments for entry into the AI generation system 102, 112, and 113 (FIG. 1) as many times has he/she wants. This iterative process can continue until the user 1 decides to stop.

In other embodiments, there may be multiple way to trigger the method 100 of generating AI generated text 205 from a text segment 200. By way of further detail, although these are the common UI implementations, notes 200 may be entered differently too. For example, notes 200 can be handwritten on the user's physical notepad (paper or electronic). The user 1 may use the user's phone or other electronic device to take a digital photograph of the notes 200 and click a ‘notes to AI generated text’ button 118. This can trigger one embodiment of the method 100, except that it will first use a handwriting recognition tool to convert raster images of the notes 200 to a digital form of the notes 200. Then, the same methods 100 that are described herein can be used to transform the notes 200 to AI generated text 205. Also, there are many input devices that may be used to enter notes 200 or trigger the process 100, such as voice or gestural command, eye tracking, a BCI (brain-computer interface), or finger on a tablet, etc. All such input devices are included within the scope of the present invention.

There are two common ways to implement the user interface 1030 that are described herein, but it will be obvious to one skilled in the art that other ways to access or implement the user interface 1030 are possible and are included within the scope of this invention. First, the method 100 or system 1000 can be triggered when the user 1 selects a text segment 200 (i.e., notes) in the text editor 1040, and then uses a pointing device (e.g., mouse) to select 118 the action to trigger the method 100 in the user interface 1030 (FIG. 10). Common implementations of this feature of the user interface 1030 include a button or a menu (FIGS. 1 and 11). In one embodiment of the present invention, a user 1 selects notes 200 in the editor 1040; and then right-clicks the selected text segment 200 to display a contextual menu. The user then selects the ‘notes to AI generated text’ button 118 (or an analogous button or link).

The method 100 or system 100 also can be triggered when the user 1 enters notes 200 in a dedicated text field 265 for notes 200 to be transformed into AI generated text 205 and selects 118 the action to trigger the method 100 in the user interface 1030. Common implementations of this user interface 1030 include a button or a menu, although other similar implementations can be used as well (FIG. 1).

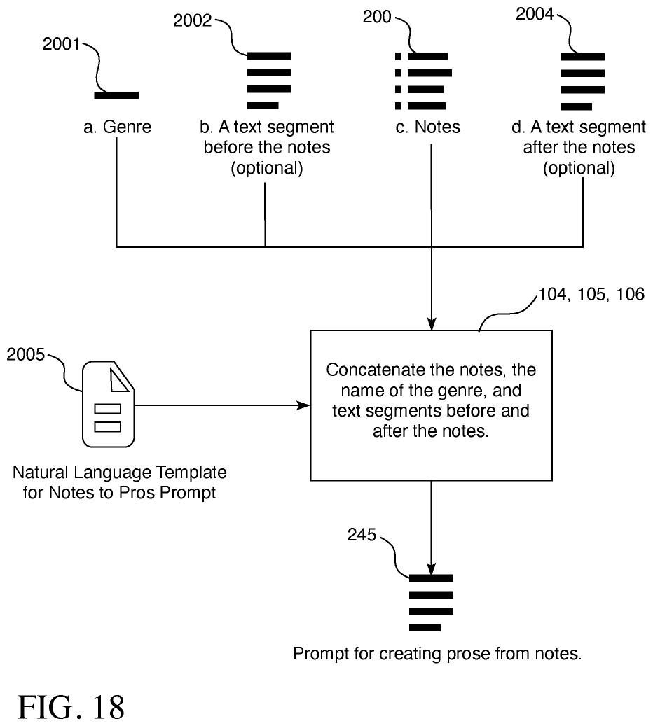

Various embodiments of the system 1000 and method 100 then concatenate 104 (or link together in a chain or series) the selected text segment 200 in the editor 1040 to predefined natural language sentences that effectively operates to generate coherent AI generated text 205 from the text segment 200 without adding new ideas or concepts. (FIG. 1 at 104, 105, and 106). The concatenation process is known and is described in further detail with respect to FIG. 18. The concatenation steps 104, 105, 106 of various embodiments of the present invention concatenate the notes 200, any text segments before the notes 2002 (optional), any text segments after the notes 2004 (optional), and the genre 2001 (optional). These embodiments concatenate the notes 200 and optional text segments before and after 2002, 2004 to a predefined natural language template 2005 (also shown at 106 in FIG. 1). The output from the concatenation 106 is a prompt 245 for creating AI generated text 205 from the notes 200 (FIG. 18).

In some embodiments of the present invention, if there is at least one paragraph (or words or sentence(s)) before or after the selected text segment 200, the string 245 generated in the previous step may optionally be further concatenated 106 with predefined natural language sentences that effectively operates to make sure to connect 207 the new AI generated text 205 to the existing paragraphs before and after the notes 2002, 2004, followed by the previous and the next texts (FIG. 1 and FIGS. 18-19).

In various embodiments, the method 100 or system 1000 then submits the concatenated string to the LLM 250 via a network connection 255 to a remote server 260 and waits for a response from the server (FIG. 1 at 107).

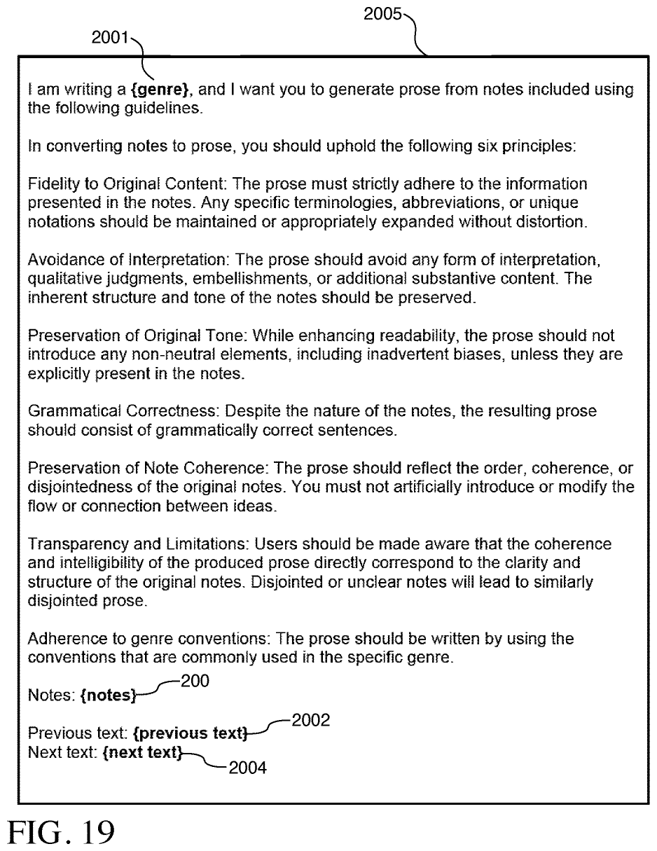

In most embodiments of the present invention, a typical prompt 245 for generating AI generated text 205 from notes 200 consists of two required text components: notes 200 and a natural language template 2005 for notes to AI generated text prompt 245 (see FIG. 18). It also can consist of any of the following optional components: genre 2001, text segments before the notes 2002, and text segment after the notes 2004 (see FIG. 18). In most but not all embodiments, notes 200 are entered by the user 1. Optionally, the user 1 can specify the genre 2001 that represents the specific type of content or text the user 1 is writing. The user 1 may also include the text segments before and after the notes 2002, 2004 if the user 1 desires to make the new AI generated text 205 and use cohesive language devices 207 to ensure the smooth flow between the new text 205 and the existing text 2002, 2004. When the user 1 initiates the method 100 to transform notes 200 into AI generated text 205, the system 1000 or method 100 combines these notes 205 and/or text before or after the notes 2002, 2004 with the template 2005 to create a unique text string 245 used as a prompt 245. FIG. 19 presents one embodiment of a typical notes-to-AI generated text template 2005. As shown in FIG. 19, {genre} 2001, {notes} 200, {previous text} 2002, and {next text} 2004 are replaced by text strings 200 (user and/or AI-generated) provided by the user 1.

For various embodiments, once a response 205 (i.e., AI generated text 205) from the LLM server 250 is received, the system 1000 and/or method 100 shall display the AI generated text 205 in a separate text field 265, which is editable by the user 1 (FIG. 1 at 108, 109). The user 1 can revise the generated text 205 (FIG. 1 at 110, 111). In one embodiment, this is a known process commonly used by AI-based LLMs wherein: (1) the LLM 250 is given a question or request in natural language; (2) the LLM 250 generates a response in natural language, optionally with machine-readable structured data; and (3) the user 1 is presented with the response via a UI 1030. In other embodiments, the server-side technology used in embodiments of the present invention may be implemented differently without using a technology known as ‘LLM 250’ (or conversational AI-based agent 250). Instead, as a non-limiting example, a dedicated algorithm for generating AI generated text 205 from notes 200 based on a large language model, similar to the one used by chatbots, can be used and is included herein as an “LLM 250”. Further, since the methods 100 and systems 1000 of some embodiments of the invention only need to instruct an LLM 250 to perform a limited number of tasks. As one nonlimiting example, while a common method to instruct LLM algorithms 250 involves the use of natural languages, such as English sentences, some embodiments of the invention may use programmatic instructions to instruct LLM algorithms 250.

If the user 1 is satisfied with the text 205 in the separate editable text field 265, the user 1 can insert the new text 205 to the editor 1040 (FIG. 1 at 112, 113 and FIG. 12). Alternatively, the user 1 may instead revise the new text 205 before inserting it to the editor 1040.

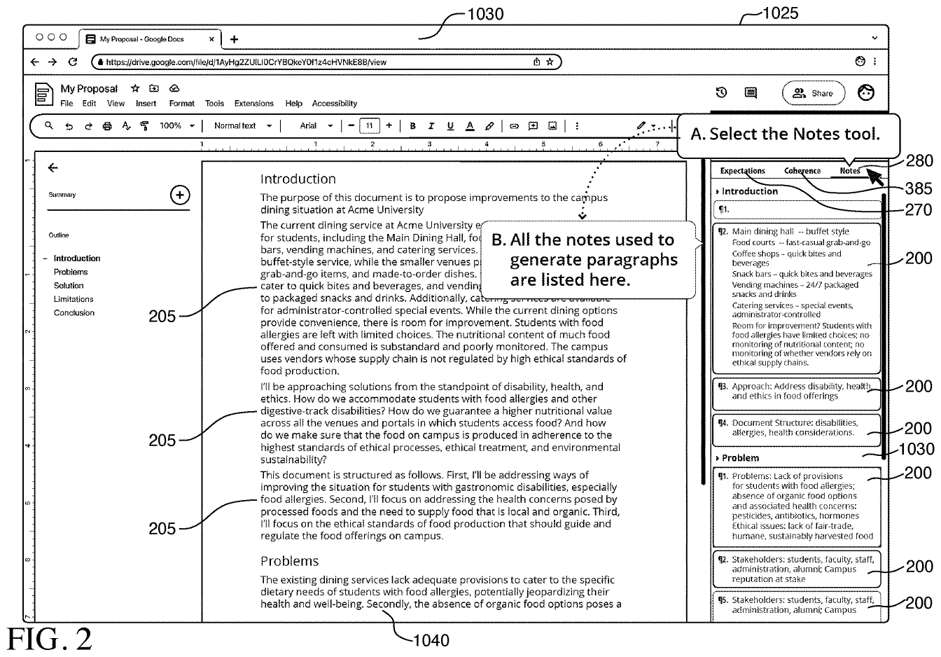

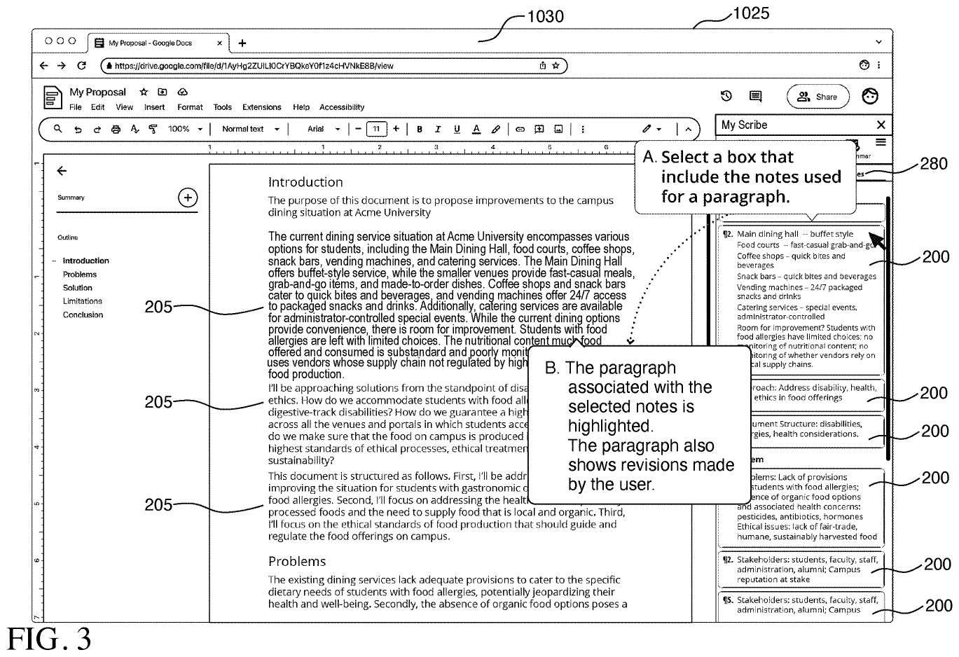

In various embodiments, the systems 1000 and methods 100 of the invention can further include a computer-implemented enhanced generative-AI-based writing system and method, using a processor 1020 with memory 1010, that enables generated text 205 to be traced back to the author's original notes 200, revisions 200 or external sources 200 (e.g., LLMs). This embodiment of the invention maintains a record of the writing process (logs 114, 116), enabling AI-generated text 205 to be traced back to the author's original notes 200 or external sources 200 (see FIGS. 2 and 3). FIG. 2 illustrates one embodiment of a system 1000 or method 100 of the present invention that handles logging, or tracking AI generated text 205 to notes 200 (also see FIG. 1 at 114, 115, 116), which is completed in the background but the user's original notes 200 are associated with AI-generated texts 205, thus allowing the user's work to be assessed based upon the information in those logs 114, 116. FIGS. 2 and 3 illustrate one embodiment of a notes tool 280 that can be displayed to the side of the text editor program 1040. A user 1 clicks on the notes tool 280 and is shown the original notes 200 and how those notes 200 correspond to the generated AI generated text 205. For this illustrative embodiment, when the user 1 selects a box of notes 200 the corresponding paragraph of AI generated text 205 is highlighted on the display 1025 (see FIG. 3).

For many embodiments of the present invention, while the user 1 is interacting with the text editor 1040 (i.e., writing and revising a text), various embodiments of the system 1000 or method 100 keep track of the following user actions:
1. text segments 200 that are directly typed into the editor 1040 by the user 1 (see FIG. 1 at 114, 115);
2. AI-generated AI generated text 205 and the original notes 200 associated with them 205 (FIG. 1 at 108, 114, 115, 116);
3. revisions 200 made to AI-generated texts 205 (FIG. 1 at 110, 115); and
4. copy-&-pasted strings 200 from external sources, such as a different word processor, web pages (including LLMs), and revisions made by the user to those texts.

The logging is completed in the background (FIG. 1 at 114, 115, 116), but the user 1 may use the user interface 1030 to access the content logged by the system (FIGS. 2 and 3). For some embodiments of the present invention, the AI-generated texts 205 are not guaranteed to be intact as these texts 205 can be copy-&-pasted into other parts of the document. Each set of original notes 200 written by the user 1 may be associated with multiple text 205 that are generated by an LLM 250.

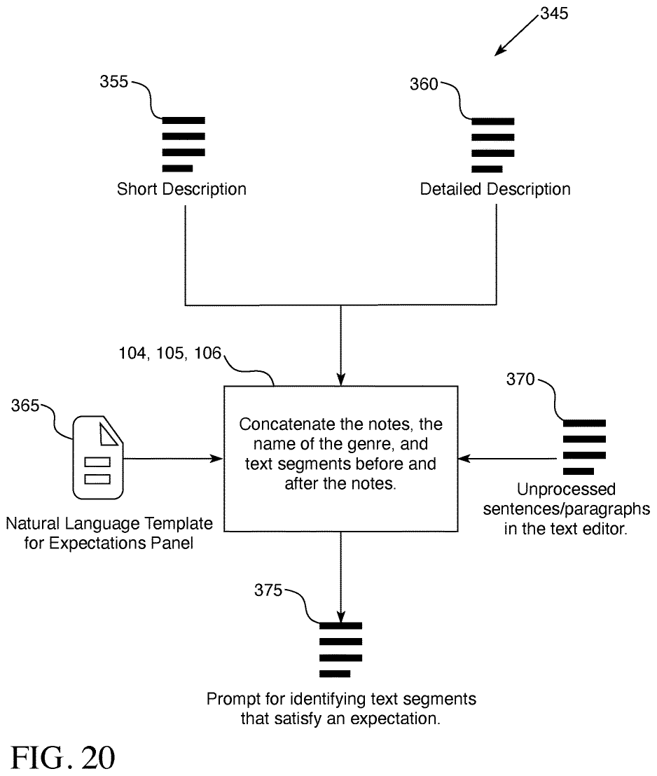

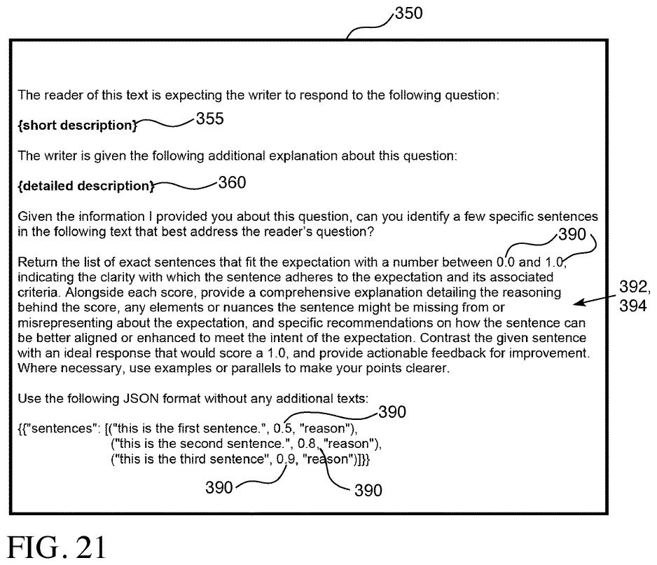

Other embodiments of the systems 1000 or methods 100 of the present invention also can include various embodiments of a computer-implemented enhanced writing method 300 (and embodiments of a system 310 using a processor 1020 with memory 1010) that can identify text segments 200 (such as sentences 230 or paragraphs 220) in the current text editor 1040 that satisfy a specific expectation 210, along with (a) a quantitative rating 320 of how well each text segment 200 satisfies the expectation 210 and (b) a textual justification 330 of the rating 320, and (c) suggestions for improvements 340 (FIG. 13 and FIGS. 20-21). FIG. 20 illustrates one embodiment of a method of generating a prompt for identifying paragraphs that meet a specific expectation 345, which is described in more detail herein. FIG. 21 illustrates one embodiment of a sample template for identifying sentences that meet a specific expectation 350. “{[S]hort description} 355 and {detailed description} 360 are replaced by specific text strings 245 associated with each expectation 210.

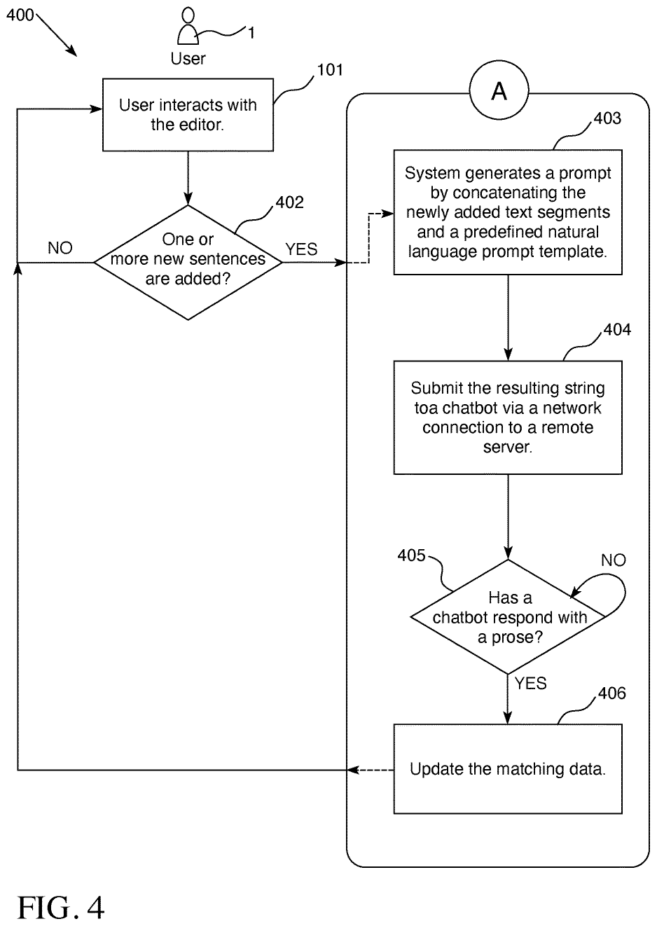

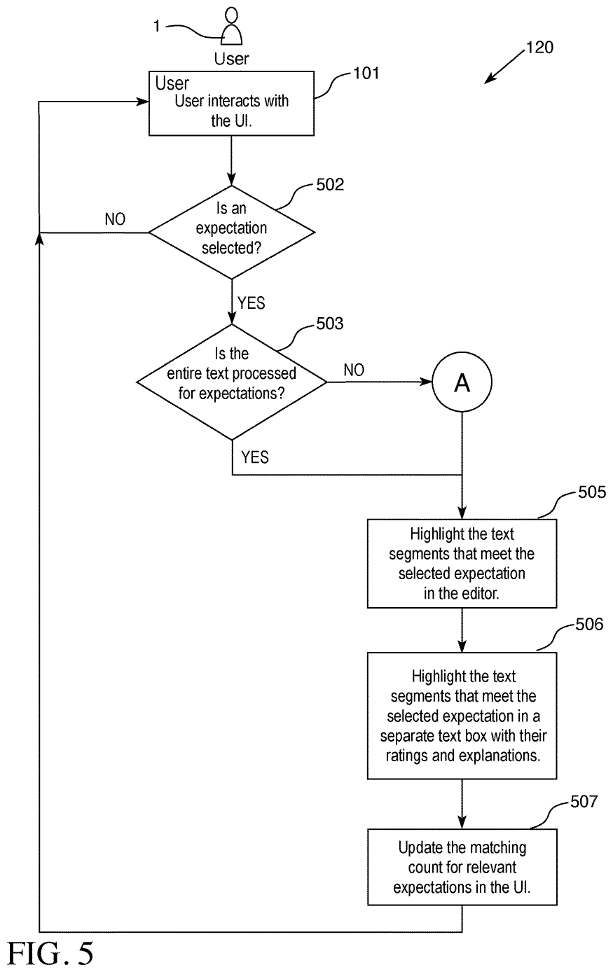

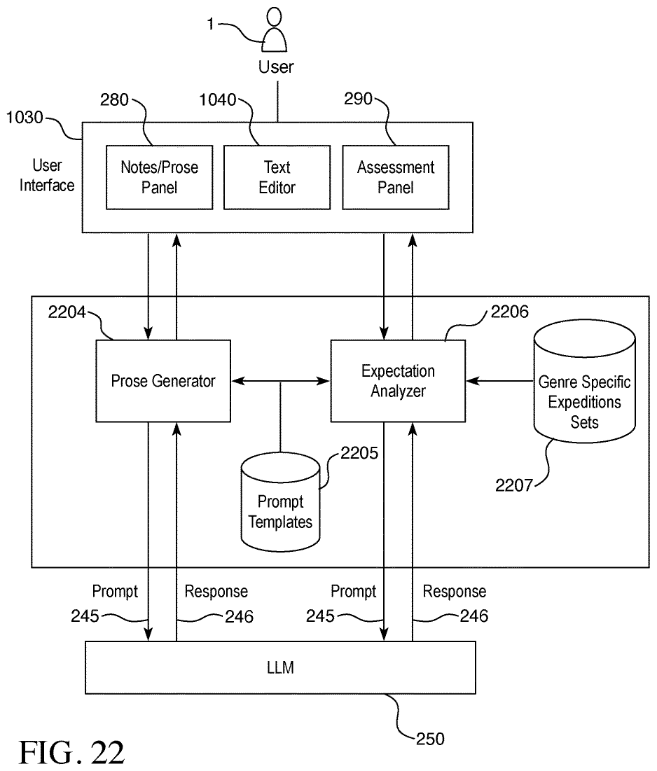

FIG. 22 illustrates a schematic overview of one embodiment of a typical implementation incorporating a method 100 or system 1000 of the present invention. As shown in FIG. 22, the user 1 engages with a user interface 1030, which enables access to three functionalities: a notes-to-AI generated text panel (or notes tool 280), a text editor 1040, and an assessment panel 290. The user interface 1030 is in two-way communication with four functionalities: an AI generated text generator 2204 (or “prose generator 2204”), prompt templates 2205, an expectation analyzer 2206, and genre specific expectation sets 2207, which interact with one another as illustrated in FIG. 22. The AI generated text generator 2204 and the expectation analyzer 2206 each send prompts 245 to the LLM 250 and receive responses 246 from the LLM 250. The prose generator 2204 in FIG. 22 performs steps 107 and 108 illustrated in FIG. 1. As illustrated in FIGS. 1 and 22, the prompt templates 2205 (in data storage) are accessible by both the prose generator 2204 and the expectation analyzer 2206. The expectations analyzer 2206 implements the method 400 for identifying sentences 230 or paragraphs 220 that meet an expectation 210 that is outlined in FIG. 4. The genre specific expectation sets 2207 are employed by the method 120 to determine if expectations 210 are met, which is shown in FIG. 5.

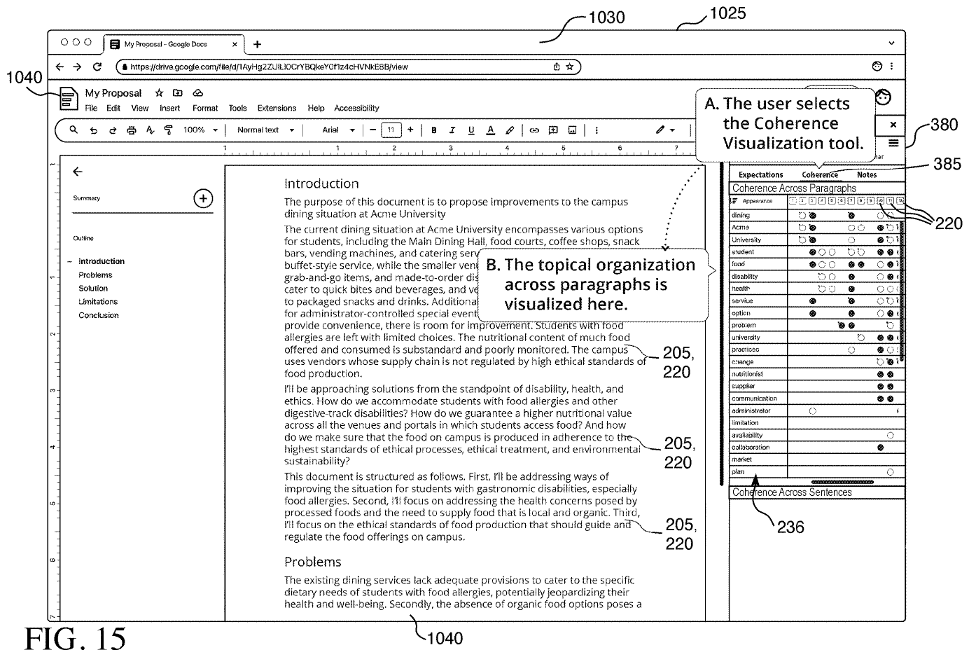

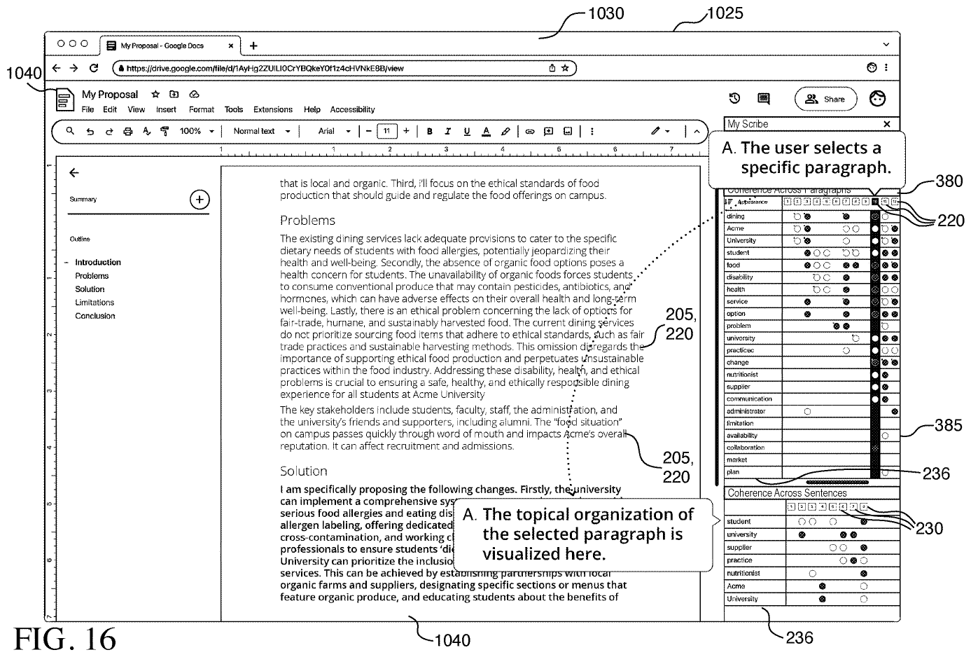

Various embodiments of the present invention can incorporate interactive visualization tools 380 that provide additional functionality. One example of an interactive visualization tool 380 is a coherence visualization tool 385, one embodiment of which is illustrated in FIG. 15. Various interactive visualization tools 380 of the present invention allow users 1 to quickly assess the presence of information anticipated by prospective readers within the text 205 (among other functionalities), with the ability to rate the quality of this information (FIGS. 15-16). Some embodiments of the present invention are configured to provide for topical organization of the user's draft (which is comprised of notes 200 and/or AI generated text 205). The coherence visualization tool 385 illustrated in FIGS. 15 and 16 provides usable access to this information to the user 1. The embodiment illustrated in FIGS. 15 and 16 provides a chart-like representation of topics 236 and their corresponding paragraphs 220 in the draft. FIG. 15 illustrates one embodiment of topical organization of a user's draft shown on a display 1025. The coherence visualization tool 385 of FIG. 15 provides a visualization of the topical organization across paragraphs in the AI generated text 205 (see FIG. 15 at A and B). FIG. 16 illustrates one embodiment of topical organization of a selected paragraph 220 shown on a display 1025. The user 1 can select a specific paragraph 220 and see what topics 236 are addressed in that paragraph 220 and identify which sentences 230 relate to those topics 236 (see FIG. 16 at A and B).

For the step of identifying a text segment 200 in various embodiments of the system 1000 and method 100 of the present invention, as the user 1 adds text segments 101, 402 to the editor 1040 (either by typing or copying the text 205 generated by an LLM 250). These embodiments of a system 1000 and method 100 monitor if one or more segments 200 of text (e.g., paragraph) are written (see FIG. 4). FIG. 4 illustrates one method for identifying text segments 200 that meet the information expectation 210 of a specific genre or an assignment 400. If one or more text segments 200 are written, various embodiments of the system 410 or method 400 evaluate whether or not new text segments 200 meet one or more of the pre-defined expectations 210 for a specific genre/assignment. This method 400 is accomplished by automatically generating a LLM prompt 245 and submitting it to the LLM 250 via a network 255 (FIG. 4 at 403, 404). A prompt 245 is generated for each expectation 210 stored in the system 410 or method 400 by concatenating the entire current draft in the text editor 1040 with a predefined natural language template (see FIGS. 20 to 21). When the response 246 from the LLM 250 becomes available, the system 410 or method 400 updates the storage of text segments 200 that match one or more information expectations 210 (FIG. 4 at 405, 406) and updates the matching count for relevant expectations in the user interface 101, 1030 (FIG. 4). The sentence matching data includes: (a) the sentence ID, (b) a rating that indicates how well each sentence meets the expectation, and (c) reasons for the rating. This process that is illustrated in FIG. 4 is triggered automatically as the user 1 revises their text; but it may also be triggered manually in a different embodiment of system 1000. Steps 403, 404, 405, and 406 in FIG. 4, as highlighted by the reference letter “A” occur in the flowchart outlined in FIG. 5 at “A”.

For various embodiments of the present invention, a unique prompt 245 is generated for each reader expectation 210. One possible implementation uses three text components: short description 360, detailed description 370, and natural language template 2005 for the expectations panel 270 (see FIG. 20). One example of the short description 360 is a brief statement of question that communicates what a typical reader expects to find in the text 210 (e.g., “What are the current conditions you propose to change?”). The detailed description 370 provides an additional longer explanation of the expectation 210. These two descriptions are typically shown to the user 1 as a means of supporting their writing process in the user interface 1030.

For various embodiments of the present invention, just before the system 1000 and method 100 starts to identify paragraphs 220 or sentences 230 that meet a specific expectation 210, the system 1000 and method 100 create a unique prompt 245 by concatenating a short description 355, a detail description 360, the paragraphs 220 that have not been processed yet 370 (see FIG. 20 at 104, 105, 106 and FIG. 21), and a template 365. In addition to identifying paragraphs 220 or sentences 230 in these embodiments, the prompt 245 also asks an LLM 250 to explain how well each paragraph 220 or sentence 230 meets the expectation 210 in terms of a number rating 390 (e.g., between 0.0 and 1.0), a written justification 392 for the rating, and suggestions 394 for improvement (FIGS. 20 and 21). The final prompt 245 is then sent to an LLM 250 to identify paragraphs 220 that meet the specific reader expectation 210. FIG. 21 presents a typical template 350 used for identifying paragraphs 220 that meet a specific expectation 210.

Finally, some embodiments of system 1000 and method 100 of the present invention provide a user 1 with the ability to retrieve the one or more text segments 200 meeting a specific expectation 210 using the user interface 1030 (see FIGS. 5 and 13-14). FIG. 5 is a flowchart of one embodiment of a process 120 for the user 1 to tell the system to highlight the sentences 230 that meet a specific expectation 210 of a specific genre or an assignment incorporated into some embodiments of the present invention. The process shown in FIG. 5 can be triggered when the user 1 selects an expectation 210 from the list of expectations 210 provided in the expectations panel 270 on the user interface 1030 (see FIG. 5 at 502 and FIG. 13); or it can be triggered automatically in the background. If the user 1 selects one of the expectations 210 listed in the user interface 1030, the system 1000 or method 100 first checks whether or not the entire text 205 in the editor 1030 has been processed for all expectations 210 (see FIG. 5 at 503 and FIG. 14). If the entire text has not been processed yet, the system completes that process (see FIG. 4, which illustrates the expectation analyzer 400). Otherwise, all the text segments 200 that meet the selected expectation 210 in the editor 1030 will be highlighted, and the same text segments 200 are also visually listed in a separate text box on the user interface along with their respective rating and explanation for the rating (see FIG. 5 at 505, 506 and FIG. 14). Then the system 1000 or method 100 updates the matching count for relevant expectations 210 in the user interface 1030 (or text editor 1040).

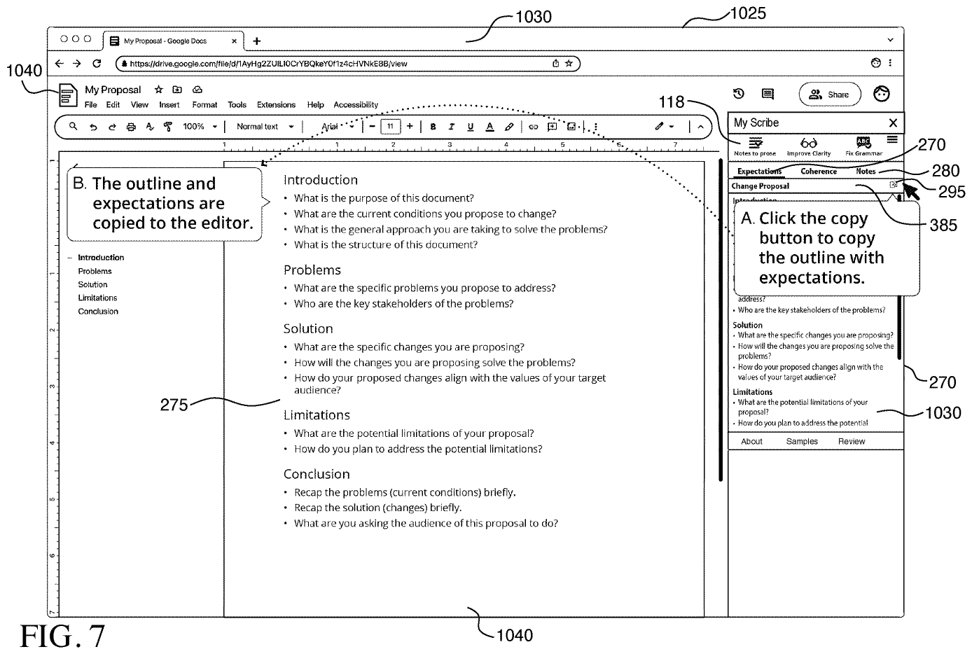

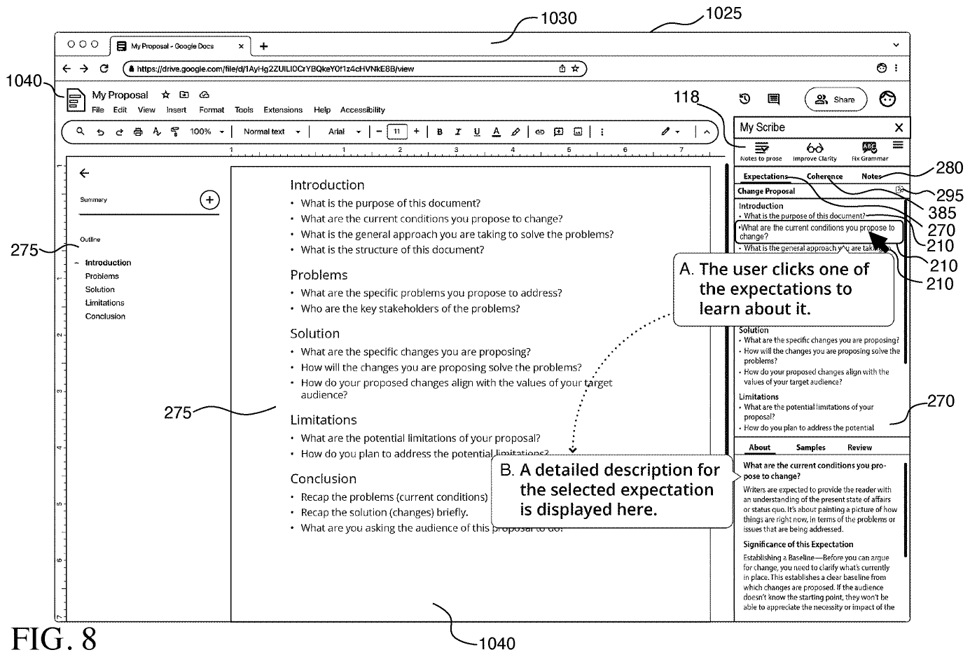

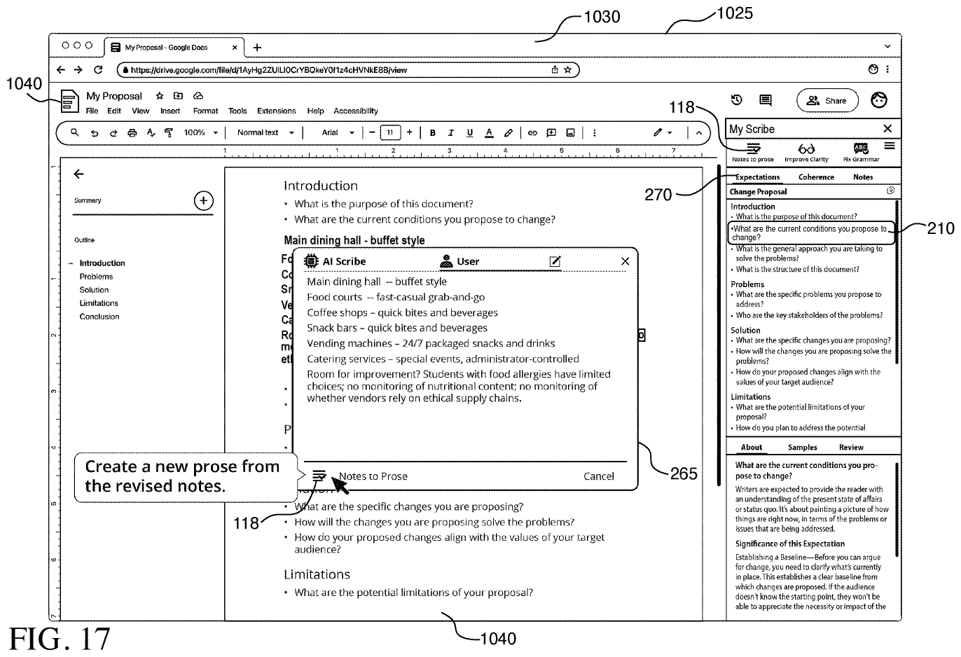

As previously mentioned, for embodiments of the invention employing expectations 210 (such as those embodiments that implement the processes in FIGS. 4 and 5), the user 1 can interface with an expectations panel 270 that displays a suggested outline 275 for a writing assignment with a set of content expectations 210. One example of which is shown in FIG. 6. FIG. 7 illustrates an outline 275 and expectations 210 copied from the user-interface 1030 and pasted into a text editor 1040. When a user 1 selects an expectation 210, the user-interface 1030 displays a detailed description 360 of the selected expectation 210 (see FIG. 8 at A and B). The user 1 writes notes 200 for an expectation 210 in the text editor 1040, an example of which is shown in FIG. 9. FIG. 10 illustrates a user 1 selecting the notes 200 in the text editor 1040 to be converted into AI generated text 205 (FIG. 10 at A and B). FIG. 11 illustrates a paragraph 205, 220 that has been generated from the text notes 200 and the user 1 can replace the selected notes 1 with the newly generated paragraph 205, 220. FIG. 12 illustrates a display 1025 with the generated paragraph 205 replacing the user-generated notes 200. FIG. 13 is one embodiment of a display 1025 showing how a user 1 completes the drafting process and the expectation panel 270 indicates if the expectations 210 are met. FIG. 14 is one embodiment of how the system 1000 and method 100 of the present invention allows the user 1 to assess if and how each expectation 210 is met. The user 1 can trace the generated text 205 back to their original notes 200 (see FIG. 2). The user 1 can select their notes 200 in the user-interface 1030 to highlight the text 205 generated from the notes 200 (see FIG. 3). FIG. 17 illustrates one embodiment of how a user 1 can revise notes 200 and generate a new paragraph 205 according to the systems 1000 and methods 100 of the present invention. FIG. 18 illustrates one method for generating a prompt 245 for generating AI generated text 205 from notes 200.

FIG. 22 is a chart of one embodiment of a method 100 (and system 1000 that can implement a method 100) of the present invention. A user 1 interacts with a user interface 1030, which enables access to a notes/AI generated text panel 280, a text editor 1040, and an assessment panel 290. The user interface 1030 provides two-way communication with an AI generated text generator 2204 and an expectation analyzer 2206, which are in communication with each other. The AI generated text generator 2204 and expectation analyzer 2206 interface with prompt templates 2205 and genre specific expeditions sets 2207 feed information into the expectations analyzer 2206. The AI generated text generator 2204 and the expectation analyzer 2206 also are in two-way communication with the LLM 250. The AI generated text generator 2204 and the expectations analyzer 2206 send prompts 245 to the LLM 250 and receive responses 246 from the LLM 250.

While the disclosure has been described in detail and with reference to specific embodiments thereof, it will be apparent to one skilled in the art that various changes and modifications can be made therein without departing from the spirit and scope of the embodiments. Thus, it is intended that the present disclosure covers the modifications and variations of this disclosure, as well as other applications of the invention, provided they come within the scope of the appended claims and their equivalents.

1. A computer-implemented method for transforming notes into machine generated text using an electronic device having one or more processors and a display with a user interface and a text editor, the method comprising executing on a processor with memory the steps of:
selecting a text segment in a text editor;
selecting, through a user interface, the generation of text from the text segment comprising:
concatenating the selected text segment to a predefined natural language text template to produce a text string;
submitting the text string to a large language model algorithm via a network connection to a remote server; and
generating text from the text segment via the large language model algorithm;
displaying the generated text in a separate text field in the user interface; and
inserting the generated text into the text editor.

2. The method of claim 1, wherein the text segment is a user generated text segment.

3. The method of claim 1, wherein the text segment is a machine generated text segment.

4. The method of claim 1 also comprising:
identifying text before or after the selected text segment and concatenating the text before or after with the selected text segment before submitting the text string to the large language model algorithm.

5. The method of claim 1 also comprising:
maintaining a log of the text segment; and
tracing the text string back to the text segment.

6. The method of claim 1 also comprising:
identifying sentences in the text editor that satisfy a specific expectation;
providing a quantitative rating of how the sentences satisfies the expectation;
providing a textual justification of the rating; and
providing suggestions for improving the machine generated text to better satisfy the expectation.

7. The method of claim 6 also comprising:
selecting the expectation in the user-interface;
highlighting sentences that address the expectation in the text editor;
highlighting sentences that address the expectation in a text box with the rating, the justification, and the suggestions; and
updating a sentence count for the expectation in the user-interface.

8. The method of claim 1, also comprising:
identifying whether new sentences have been added in the text editor;
generating a prompt by concatenating the new sentences as text segments and a predefined natural language prompt template to generate a text string;
submitting the generated text string to a large language model algorithm via a network connection to a remote server;
generating machine generated text in response to the submitted generated text string; and
updating the sentences in the text editor.

9. The method of claim 1, also comprising, prior to the step of concatenating, identifying any genre, text segments before the selected text segment, or text segments after the selected text segment; and then concatenating any identified genre, text segments before the selected text segment, or text segments after the selected text segment with the text segments to generate machine generated text.

10. An electronic device, comprising:
a display;
a memory;
one or more processors; and
one or more programs, wherein the one or more programs are stored in the memory and configured to be executed by the one or more processors, wherein the one or more programs include instructions for:
selecting a text segment in a text editor;
selecting, through the user-interface, to generate machine generated text from the text segment;
concatenating the selected text segment to a predefined natural language text template to produce a text string;
submitting the text string to a large language model algorithm via a network connection to a remote server;
generating machine generated text from the text segment via the large language model algorithm;
displaying the machine generated text in a separate text field; and
inserting the machine generated text into the text editor.

11. The device of claim 10, wherein the text segment is a user generated text segment.

12. The device of claim 10, wherein the text segment is a machine generated text segment.

13. The device of claim 10 also comprising:
identifying text before or after the text segment and concatenating the text before or after with the selected text segment before submitting the text string to the large language model algorithm.

14. The device of claim 10 also comprising:
maintaining a log of the text segment; and
tracing the text string back to the text segment.

15. The device of claim 10 also comprising:
identifying sentences in the text editor that satisfy a specific expectation;
providing a quantitative rating of how the sentences satisfies the expectation;
providing a textual justification of the rating; and
providing suggestions for improving the machine generated text to better satisfy the expectation.

16. The device of claim 15 also comprising:
selecting the expectation in the user-interface;
highlighting the sentences that address the expectation in the text editor;
highlighting the sentences that address the expectation in a text box with the rating, the justification, and suggestions; and
updating a sentence count for the expectation in the user-interface.

17. The device of claim 10, also comprising:
identifying whether new sentences have been added in the text editor;
generating a prompt by concatenating the new sentences as text segments and a predefined natural language prompt template to generate a text string;
submitting the text string to a large language model algorithm via a network connection to a remote server;
generating machine generated text in response to the submitted text string; and
updating the sentences in the text editor.

18. The device of claim 10, also comprising, prior to the step of concatenating, identifying any genre, text segments before the selected text segment, or text segments after the selected text segment; and then concatenating any identified genre, text segments before the selected text segment, or text segments after the selected text segment with the text segments to generate machine generated text.

19. A system for transforming notes into machine generated text using an electronic device having one or more processors and a display with a user interface and a text editor, comprising:
a user interface accessible via the display comprising:
a notes/machine generated text panel;
a text editor; and
an assessment panel, wherein the user interface is in two-way communication with a machine generated text generator and an expectations analyzer, which communicate with each other;
prompt templates that interface with the machine generated text generator and the expectation analyzer;
genre specific expectations sets which provide information to the expectations analyzer; and
a large language model algorithm that receives prompts from the machine generated text generator and the expectation analyzer and sends responses to the machine generated text generator and the expectation analyzer.

20. The system of claim 19, wherein text segments are selected via the user interface and are converted to machine generated text through the interactions of the machine generated text generator, the expectation analyzer, the prompt templates, the genre specific expectations sets, and the large language model algorithm.
